(19) United States
(12) Patent Application Publication
(10) Pub. No.: US 2007/0041029 A1
(43) Pub. Date: Feb. 22, 2007

(54) Image forming apparatus with an image editing function and a method thereof

(76) Inventor: Yeong-eek Yoo, Anyang-si (KR)

Correspondence Address: STANZIONE & KIM, LLP, 919 18TH STREET, N.W., SUITE 440, WASHINGTON, DC, 20006, US

(21) Appl. No.: 11/417,156

(22) Filed: May 4, 2006

(30) Foreign Application Priority Data
Aug. 17, 2005 (KR) 2005-75452

(51) Int. Cl. G06F 3/12

(52) U.S. Cl. 358/1.13; 358/452

(57) ABSTRACT

An image forming apparatus with an image editing function and a method thereof. The image forming apparatus includes a touch screen unit to display an image and to receive an editing command for the image by touch, a main control unit to edit image data that corresponds to the image according to the editing command and to convert the image data into printable pictorial image data, and a printing unit to output the pictorial image data on printing paper. Accordingly, an image can be edited and printed without a terminal device, such as a personal computer.

### CROSS-REFERENCE TO RELATED APPLICATIONS

This application claims the benefit under 35 U.S.C. § 119(a) of Korean Patent Application No. 2005-75452, filed Aug. 17, 2005 in the Korean Intellectual Property Office, the entire contents of which are incorporated herein by reference.

### BACKGROUND OF THE INVENTION

1. Field of the Invention

The present general inventive concept relates to an image forming apparatus with an image editing function and a method thereof. More particularly, the present general inventive concept relates to an image forming apparatus with an image editing function to edit and print an image downloaded from a memory card or an external device through a touch screen, and a method thereof.

2. Description of the Related Art

Recently, digital cameras have been gaining widespread popularity, and users want to be able to store images taken by a digital camera in storing media, such as a hard disk drive of a computer. Users also want to be able to output the images on paper using an image forming apparatus.

Accordingly, the image forming apparatus such as a photo printer has been developed. The photo printer is a printer dedicated to a digital picture which prints an image stored in the digital camera connected by a PicBridge, or an image stored in a portable memory card. The photo printer can output a picture with similar quality to a general film picture using a printing paper dedicated to printing pictures (e.g., photo paper).

FIG. 1 is a view illustrating a conventional image forming apparatus 10.

Referring to FIG. 1, the conventional image forming apparatus 10 comprises a memory card interface unit 12, an external device interface unit 14, a manipulation unit 16, and a display unit 18.

A memory card (not shown) that stores image data, which corresponds to an image to print, may be mounted in the memory card interface unit 12. The external device interface unit 14 is connected to an external device (not shown) such as a digital camera.

The manipulation unit 16 has a variety of manipulation keys which a user can manipulate to control operation of the image forming apparatus 10. The display unit 18 is a liquid crystal display (LCD) window to show a state of the image forming apparatus 10.

If the memory card is mounted to the memory card interface unit 12 or the digital camera is connected to the external device interface unit 14, the image forming apparatus 10 downloads the image data from the memory card or the external device and prints an original image from the image data on a printing paper according to the user's manipulation.

When a user wants to edit the original image and print the edited image, a terminal device 20 such as a personal computer is typically needed. In other words, the image data stored in the memory card or the digital camera are downloaded to the terminal device 20, an image editing program is executed on the terminal device 20, and the original image can be edited using the image editing program running on the terminal device 20. Subsequently, image data that corresponds to the edited image are transmitted to the image forming apparatus 10 to be printed. However, when there is no terminal device 20 connected to the image forming apparatus 10, it is typically impossible to edit the original image.

If more functions are added to the image forming apparatus 10, more manipulation keys to implement the functions have to be added to the manipulation unit 16. For example, when number keys to select a number of sheets to print are added to the manipulation unit 16, the added keys increase cost and it may be impossible to add the number keys due to a size of the image forming apparatus 10.

### SUMMARY OF THE INVENTION

The present general inventive concept provides an image forming apparatus with an image editing function using a touch screen which can replace a variety of manipulation keys to edit an image without a terminal device and a method thereof.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming apparatus, including a touch screen unit to display a an image and to receive an editing command for the image by a touch, a main control unit to edit image data that corresponds to the image according to the editing command and to convert the image data into printable pictorial image data, and a printing unit to output the pictorial image data to printing paper.

The touch screen unit may display a variety of manipulation keys with the image in a graphical user interface (GUI) to receive a user command by touch.

The image forming apparatus may further include a touch screen control unit to convert the user command input through the touch screen unit into command data to transmit to the main control unit, and to control the touch screen unit to display the image data edited in the main control unit.

The image forming apparatus can further include a memory card interface unit in which a memory card that stores the image data that corresponds to the image is mounted and to download the image data selected according to a select command input through the touch screen unit from the memory card.

The image forming apparatus can further include an external device interface unit to download the image data selected according to the select command input through the touch screen unit from an external device in communication therewith.

The foregoing and/or other aspects of the present general inventive concept are also achieved by providing an image forming apparatus, including at least one connection interface unit connectable to at least one of a memory card and a camera device, and a touch screen unit to receive one or more user commands to manipulate one or more images stored in the at least one of the memory card and the camera device without being connected to a terminal device.

The foregoing and/or other aspects of the present general inventive concept are also achieved by providing an image editing method of an image forming apparatus having a touch screen unit to receive an editing command for a selected image by a touch, the method including displaying the selected image on the touch screen unit, receiving the editing command for the selected image through the touch screen unit, editing image data that corresponds to the image based on the editing command, converting the edited image data into printable pictorial image data, and outputting the pictorial image data on printing paper.

The method may further include downloading the image data from either a memory card or an external device which stores the image data that corresponds to the selected image.

The method may further include signal-processing the edited image data, and displaying the edited image data on the touch screen unit.

The receiving of the editing command for the selected image through the touch screen unit includes receiving the editing command input via a graphic user interface (GUI) on the touch screen unit, which displays a variety of manipulation keys with the selected image.

The foregoing and/or other aspects of the present general inventive concept are also achieved by providing a method of editing one or more images in an image forming apparatus that is not connected to a terminal device, the method including detecting whether a memory card or a camera device is connected to the image forming apparatus, downloading image data of a selected image from the memory card or the camera device when it is determined that the memory card or the camera device is connected to the image forming apparatus, editing the downloaded image data when an editing command is received via a touch screen unit of the image forming apparatus, and printing the image data when a printing command is received via the touch screen unit of the image forming apparatus.

The foregoing and/or other aspects of the present general inventive concept are also achieved by providing a graphical user interface (GUI) of an image forming apparatus, the GUI including a first portion to display image data of a selected image received from one of a memory card and a camera device, and a second portion to receive one or more touch commands and to edit the displayed image data according to the one or more received touch commands.

The foregoing and/or other aspects of the present general inventive concept are also achieved by providing a computer readable medium containing executable code to perform an image editing method of an image forming apparatus having a touch screen unit to receive an editing command for a selected image by a touch, the method including displaying the selected image on the touch screen unit, receiving the editing command for the selected image through the touch screen unit, editing image data that corresponds to the selected image based on the editing command, converting the edited image data into printable pictorial image data, and outputting the pictorial image data on printing paper.

### BRIEF DESCRIPTION OF THE DRAWINGS

The above and/or other aspects of the present general inventive concept will become more apparent by describing in detail exemplary embodiments thereof with reference to the attached drawing figures, wherein;

FIG. 1 is a view illustrating a conventional image forming apparatus;

FIG. 2 is a view illustrating an image forming apparatus according to an embodiment of the present general inventive concept;

FIG. 3 is a schematic block diagram illustrating the image forming apparatus of FIG. 2 according to an embodiment of the present general inventive concept;

FIG. 4 is a view illustrating a touch screen unit of an image forming apparatus according to an embodiment of the present general inventive concept; and

FIG. 5 is a flow chart illustrating an operation of an image forming apparatus according to an embodiment of the present general inventive concept.

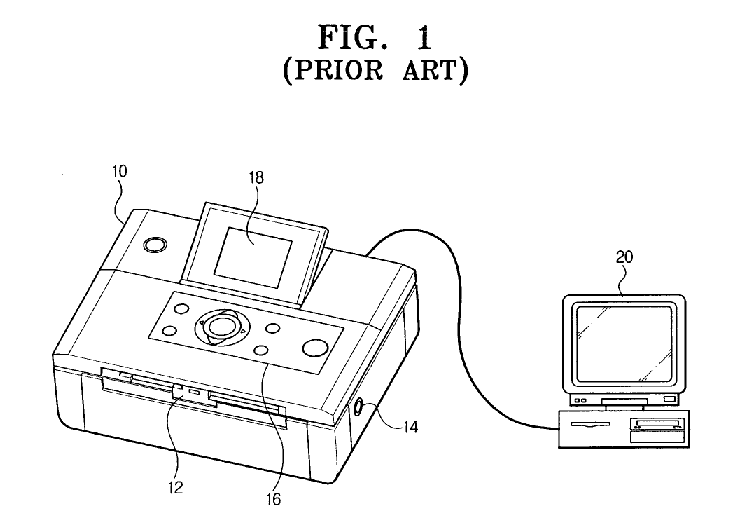

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

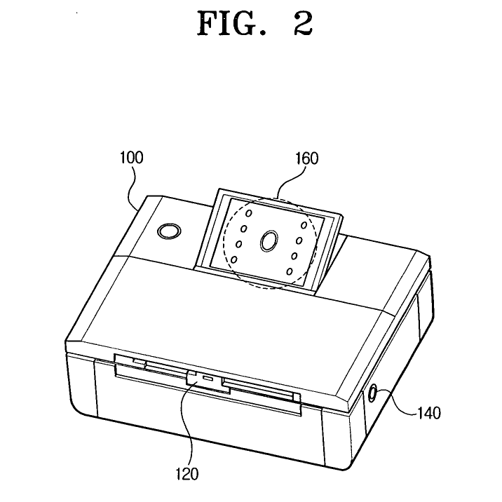

FIG. 2 is a view illustrating an image forming apparatus 100 according to an embodiment of the present general inventive concept.

Referring to FIG. 2, the image forming apparatus 100 includes a memory card interface unit 120, an external device interface unit 140, and a touch screen unit 160.

A memory card (not shown) that stores image data that corresponds to an image to print may be mounted in the memory card interface unit 120. The external device interface unit 140 is connectable to an external device such as a digital camera.

The touch screen unit 160 is an input part that can replace a use of manipulation keys such that a user touches the touch screen unit 160 with a hand or object to select or perform a desired operation. In other words, the touch screen unit 160 displays a graphic user interface (GUI) that corresponds to manipulation keys to control operation of the image forming apparatus 100 and the user touches the GUI displayed on the touch screen unit 160 so that operation of the image forming apparatus 100 can be controlled thereby.

Additionally, the touch screen unit 160 processes and displays the image data downloaded from the memory card or the external device, and the user can edit the image by touching the touch screen unit 160.

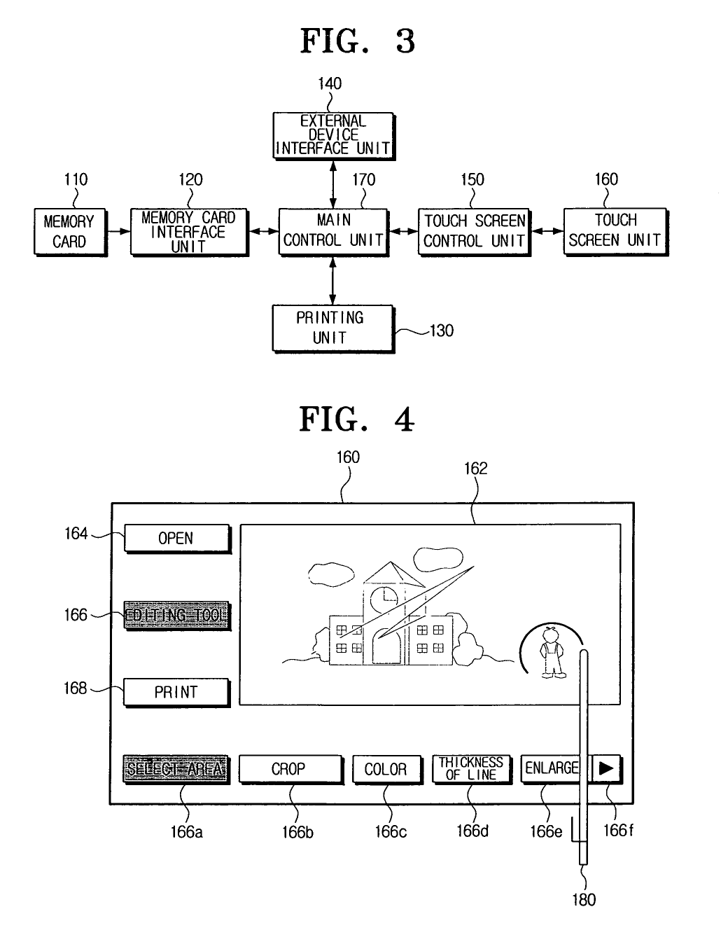

FIG. 3 is a schematic block diagram illustrating the image forming apparatus 100 of FIG. 2, according to an embodiment of the present general inventive concept.

Referring FIG. 3, the image forming apparatus includes the memory card interface unit 120, a printing unit 130, the external device interface unit 140, a touch screen control unit 150, the touch screen unit 160, and a main control unit 170.

A memory card 110 that stores image data corresponding to an image to print can be mounted in the memory card interface unit 120. According to control of the main control unit 170 (described below), the image data may be downloaded from the memory card 110 and transmitted to the main control unit 170. The memory card 110 may be a multimedia card (MMC), smart media (SM) card, memory stick (MS), secure digital (SD) card, compact flash (CF) card, micro drive (MD) card, or the like.

The external device interface unit 140 is connectable to the external device (not shown) such as the digital camera to download the image data from the external device according to the control of the main control unit 170, and the external device interface unit 140 transmits the image data to the main control unit 170. PictBridge can be used as the external device interface unit 140 and supports a function of printing an image stored in the digital camera without a terminal device, such as a host computer.

The main control unit 170 processes the image data that is downloaded from the memory card 110 or the external device into printable pictorial image data. That is, the main control unit 170 performs digital signal processing such as scaling, gamma conversion, and error diffusion for the image data to generate the printable pictorial image data.

The printing unit 130 prints the generated pictorial image data on the printing paper (e.g., photo paper) usable to print a picture according to control of the main control unit 170.

The touch screen unit 160 displays the GUI that corresponds to the manipulation keys to control operation of the image forming apparatus and displays the image that corresponds to the image data downloaded from the memory card 110 or the external device.

The touch screen control unit 150 receives and processes the image data from the main control unit 170, and converts the image data into video data displayable on the touch screen unit 160. In addition, the touch screen control unit 150 generates command data that corresponds to a user command input through the touch screen unit 160 and transmits the command data to the main control unit 170. That is, when the user touches the touch screen unit 160 and inputs an editing command to edit the image that corresponds to the downloaded image data, the touch screen control unit 150 converts the editing command into command data which can be processed by the main control unit 170 and transmits the command data to the main control unit 170.

The main control unit 170 edits the image data based on the command data and controls the touch screen control unit 150 to display the image on the touch screen unit 160. If a printing command is input via the touch screen unit 160, the main control unit 170 converts the edited image data into the printable pictorial image data and controls the printing unit 130 to print the pictorial image data on the printing paper.

FIG. 4 is a view illustrating a touch screen unit of an image forming apparatus according to an embodiment of the present general inventive concept. The touch screen unit may correspond to the touch screen unit 160 of FIGS. 2 and 3. Accordingly, for illustration purposes, the touch screen unit 160 is described below with reference to FIGS. 2 and 3.

Referring to FIG. 4, the touch screen unit 160 of the image forming apparatus displays manipulation keys 164, 166, 168, 166a, . . . , 166f to input a variety of commands and displays an image display window 162.

If a user touches an open key 164 to select image data to print or edit, the main control unit 170 downloads the selected image data from the memory card 110 or the external device based on a user selecting command. According to control of the main control unit 170, the touch screen control unit 150 displays the selected image data on the image display window 162.

If the user touches an editing tool 166, a variety of editing keys 166a, . . . , 166f to edit an image, which corresponds to the displayed image data, are displayed on the touch screen unit 160. The user can edit the image displayed on the image display window 162 using the editing keys 166a, . . . , 166f.

For example, if the user touches a select area key 166a, the user can select an image area from the display image to print or edit. If the user touches a crop key 166b, the user can paste the selected image area on another image or delete the selected image area.

Additionally, if the user touches a color key 166c, a color of the selected image area or a line drawn by a touch pen 180 can be altered, and if the user touches a thickness of line key 166d, a thickness of a line of the touch pen 180 can be designated. If the user touches an enlarge key 166e, the selected image area is enlarged and displayed on the touch screen unit 160.

A [symbol] key 166f (i.e., a more key) is a manipulation key to show extra editing tools which are not displayed on the touch screen unit 160.

By touching a print key 168, the printing command to print the edited image on the printing paper is input, and also a number of sheets for printing and a size of printing can be adjusted. It should be understood that the manipulation keys illustrated in FIG. 4 on the image display window 162 are not intended to limit the scope of the present general inventive concept, and other arrangements of manipulation keys may alternatively be used with the present general inventive concept. Additionally, “key” as used in this detailed description can be understood as referring to a portion of the GUI on the touch screen unit 160 that indicates a user command when touched by a user or object.

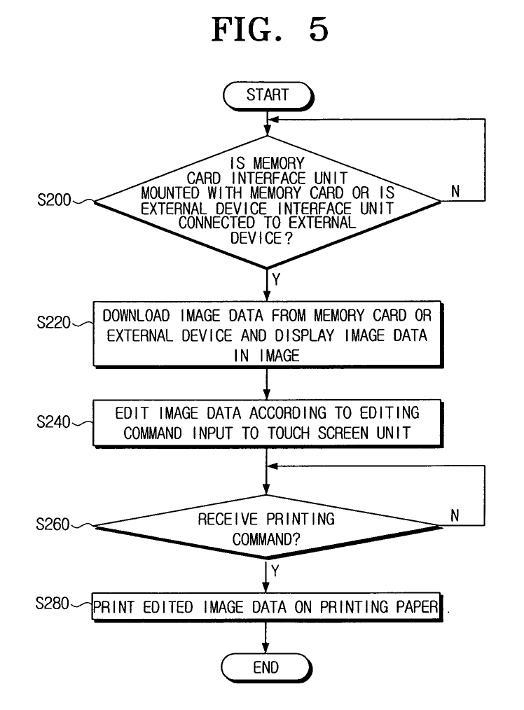

FIG. 5 is a flow chart illustrating a method of operation of an image forming apparatus according to an embodiment of the present general inventive concept. The method of FIG. 5 may be performed by the image forming apparatus of FIGS. 2 and 3. For example, the method of FIG. 5 may be performed by the main control unit 170 of the image forming apparatus. Accordingly, the method of FIG. 5 is described below with reference to FIGS. 2-4.

Referring to FIG. 5, it is determined whether the memory card 110 is mounted or whether the external device is connected. In other words, the main control unit 170 detects whether the memory card 110 is mounted in the memory card interface unit 120 or whether the external device interface unit 140 is connected to the external device such as the digital camera (operation S200).

If memory card 110 is mounted in the memory card interface unit 120 or the external device interface unit 140 is connected to the external device, image data is downloaded from the memory card 110 or the external device, and the image data is displayed on the touch screen unit 160, as an image. That is, if a user selects the image data to edit or print using the open key 164, the image data is downloaded from the memory card 110 or the external device, is converted into video data, and is displayed on the touch screen unit 160 (operation S220).

According to a user command input to the touch screen unit 160, the image data can be edited. More specifically, if the user edits the image displayed on the touch screen unit 160 using the touch pen 180 or the editing keys 166a, . . . , 166f displayed on the touch screen unit 160, the touch screen control unit 150 converts the editing command into command data and transmits the command data to the main control unit 170. Subsequently, the main control unit 170 edits the image data according to the editing command, and the touch screen control unit 150 converts the edited image data into the video data and displays the video data on the touch screen unit 160 (operation S240).

If the user inputs the printing command through the touch screen unit 160, the touch screen control unit 150 transmits the printing command to the main control unit 170 (operation S260).

The main control unit 170 converts the edited image data into pictorial image data and prints the pictorial image data on the printing paper (operation S280).

According to the above process, the image can be edited and printed in the image forming apparatus.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software.

As can be appreciated from the above description, according to the various embodiments of the present general inventive concept, a user edits and prints an image displayed on a touch screen by hand or touch pen using a touch screen instead of a variety of manipulation keys so that an image forming apparatus can be compact in size and facilitate use.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a touch screen unit to display an image and to receive an editing command for the image by a touch;
a main control unit to edit image data that corresponds to the image according to the editing command and to convert the image data into printable pictorial image data; and
a printing unit to output the pictorial image data to printing paper.

2. The apparatus of claim 1, wherein the touch screen unit displays a variety of manipulation keys with the image in a graphical user interface (GUI) to receive a user command by touch.

3. The apparatus of claim 2, further comprising:
a touch screen control unit to convert the user command input through the touch screen unit into command data to transmit to the main control unit, and to control the touch screen unit to display the image data edited in the main control unit.

4. The apparatus of claim 1, further comprising:
a memory card interface unit in which a memory card that stores the image data that corresponds to the image is mounted and to download image data selected according to a select command input through the touch screen unit from the memory card.

5. The apparatus of claim 1, further comprising:
an external device interface unit to download the image data selected according to a select command input through the touch screen unit from an external device in communication therewith.

6. An image forming apparatus, comprising:
at least one connection interface unit connectable to at least one of a memory card and a camera device; and
a touch screen unit to receive one or more user commands to manipulate one or more images stored in the at least one of the memory card and the camera device without being connected to a terminal device.

7. The apparatus of claim 6, further comprising:
a printing unit to print the manipulated one or more images on picture paper when a printing command is received via the touch screen unit.

8. The apparatus of claim 6, wherein the touch screen unit displays a graphical user interface (GUI) including a selected image displayed thereon and manipulation portions of the touch screen unit.

9. The apparatus of claim 8, wherein the manipulation portions of the touch screen unit comprise one or more of:
an open image portion to open the selected image when touched;
an editing tool portion to edit the selected image when touched; and
a print image portion to print the selected image when touched.

10. The apparatus of claim 9, wherein the editing tool portion comprises one or more of:
a select area portion to select an area within the selected image when touched;
a crop portion to crop the selected image when touched;
a color portion to change a color of a part of the selected image when touched;
a thickness of line portion to change a thickness of a line in the selected image when touched; and
an enlarge portion to enlarge the selected image when touched.

11. The apparatus of claim 9, wherein the manipulation portions of the touch screen unit further comprise a more selection portion to display hidden functions when touched.

12. The apparatus of claim 6, wherein the at least one connection interface unit comprises:
a memory card interface unit in which a memory card is mountable and to receive first image data from the memory card when the memory card is mounted therein; and
an external device interface unit to which the camera device is connectable and to receive second image data from the camera device.

13. The apparatus of claim 6, further comprising:
a touch screen control unit to detect a portion of the touch screen unit that is touched and to generate corresponding command data based thereon.

14. The apparatus of claim 13, further comprising:
a main control unit to receive the command data from the touch screen control unit and to manipulate the one or more images according to the received command data.

15. The apparatus of claim 14, wherein the main control unit receives image data associated with the one or more images, converts the received images data to video data, and displays the video data on the touch screen unit.

16. The apparatus of claim 15, wherein when the one or more images are edited, the main control unit edits the image data associated with the one or more images, re-converts the edited image data to video data, and displays the re-converted video data on the touch screen unit.

17. The apparatus of claim 6, wherein the one or more user commands comprise at least one of:
a selection command to select one of the one or more images to be manipulated when a first portion of the touch screen unit is touched;
an editing command to edit the selected image when one or more second portions of the touch screen unit is touched; and
a printing command to print the selected image when a third portion of the touch screen unit is touched.

18. An image editing method of an image forming apparatus having a touch screen unit to receive an editing command for a selected image by a touch, the method comprising:
displaying the selected image on the touch screen unit;
receiving the editing command for the selected image through the touch screen unit;
editing image data that corresponds to the selected image based on the editing command;
converting the edited image data into printable pictorial image data; and
outputting the pictorial image data on printing paper.

19. The method of claim 18, further comprising:
downloading the image data from either a memory card or an external device which stores the image data that corresponds to the selected image.

20. The method of claim 18, further comprising:
signal-processing the edited image data; and
displaying the edited image data on the touch screen unit.

21. The method of claim 18, wherein the receiving of the editing command for the selected image through the touch screen unit comprises receiving the editing command via a graphic user interface (GUI) on the touch screen unit, which displays a variety of manipulation keys with the selected image.

22. A method of editing one or more images in an image forming apparatus that is not connected to a terminal device, the method comprising:
detecting whether a memory card or a camera device is connected to the image forming apparatus;
downloading image data of a selected image from the memory card or the camera device when it is determined that the memory card or the camera device is connected to the image forming apparatus;
editing the downloaded image data when an editing command is received via a touch screen unit of the image forming apparatus; and
printing the image data when a printing command is received via the touch screen unit of the image forming apparatus.

23. A graphical user interface (GUI) of an image forming apparatus, the GUI comprising:
a first portion to display image data of a selected image received from one of a memory card and a camera device; and
a second portion to receive one or more touch commands and to edit the displayed image data according to the one or more received touch commands.

24. A computer readable medium containing executable code to perform an image editing method of an image forming apparatus having a touch screen unit to receive an editing command for a selected image by a touch, the method comprising:
displaying the selected image on the touch screen unit;
receiving the editing command for the selected image through the touch screen unit;
editing image data that corresponds to the selected image based on the editing command;
converting the edited image data into printable pictorial image data; and
outputting the pictorial image data on printing paper.
